(19) United States
(12) Patent Application Publication
(10) Pub. No.: US 2016/0184874 A1
(43) Pub. Date: Jun. 30, 2016

(54) Fabric With A Polymer Layer With A Riblet Structure

(71) Applicant: FRAUNHOFER GESELLSCHAFT ZUR FÖRDERUNG ANGEWANDTEN FORSCHUNG E.V., München (DE)

(72) Inventors: Helmut Schmid, Freudenstadt (DE); Norbert Eisenreich, Karlsruhe (DE); Peter Homa, Rauschenberg (DE)

(73) Assignee: Fraunhofer Gesellschaft zur Förderung der Angewandten Forschung E.V., München (DE)

(21) Appl. No.: 14/902,598

(22) PCT Filed: Jul. 17, 2014
(86) PCT No.: PCT/EP2014/065347

§ 371 Date: Jan. 4, 2016

(30) Foreign Application Priority Data
Jul. 18, 2013 (DE) 102013214075.4

(51) Int. Cl. B08B 17/02; D03D 15/00; D06B 1/00; D06N 3/12; B32B 27/12; D06N 3/00; D06N 3/04; D03D 1/00; B32B 5/02

(52) U.S. Cl. CPC B08B 17/02; D03D 1/00; D03D 15/00; D06B 1/00; B32B 5/024; B32B 27/12; D06N 3/0006; D06N 3/0022; D06N 3/0034; D06N 3/0036; D06N 3/0063; D06N 3/045; D06N 3/047; D06N 3/128; B32B 2307/7145; B32B 2307/746; B32B 2603/00; B32B 2605/12; B32B 2605/18; D10B 2101/06; D10B 2331/02; D10B 2331/04

(57) ABSTRACT

The invention relates to a fabric comprising at least one weft thread and at least one warp thread, wherein the fabric exhibits a polymer layer on at least one surface, characterized in that the diameter of the weft thread is larger than the diameter of the warp thread, the use of this fabric, as well as a process for the production thereof.

The present invention relates to a fabric comprising at least one weft and at least one warp, wherein the fabric comprises a polymer layer on at least one surface, wherein the diameter of the weft is larger than the diameter of the warp. The invention also relates to the use of such a fabric, a molded body with a corresponding fabric as well as to a method for production of such a fabric.

For reduction of the flow resistance which a liquid or gaseous medium opposes to an object moving in this medium, in fluid mechanics often at least partial areas of the object surface are roughened. Nature also uses surfaces with targeted structuralizing. For example, the skin of a shark is made from a multitude of microscopic grooves which are aligned parallel to each other in the direction of water flow, and thus enable the shark to gain high speeds with a minimum expenditure of energy.

Topographic replicas of this sharkskin, also called riblet structure, on the basis of polymer films are nowadays applied in aeronautical engineering or in equipping of water craft (see, eg, CN 101 966 753 A and KR 20120001486 A). In EP 2505853 A2 and EP 2011/087414 A1, however, the use of such a microstructure on rotor blades of wind turbines for noise reduction is described as well. WO 00/34651 A1 further points to the positive effect of avoiding ice shedding of such rotor blades through the water-repellent properties of these surfaces. The water-repellent and thus self-cleaning properties of the surfaces can be even further increased (see, for example, US 2012/0142814 A1) by additional enhancement of hydrophobicity.

In particular with regard to the control of (bio) fouling the properties of surfaces with riblet structure can also be used successfully. In WO 2012/119965 A2 an approach how to use a template to emboss a fish scale or sharkskin pattern in a surface of a composite system is described. The composite system described therein is applied to water craft, thus preventing the growth of algae, plants and animals, especially mussels and barnacles on the hull being in contact with water (biofilm formation). The microbial population of the surface on the one hand changes the fluid resistance of the vessel as a molded body in the water, but additionally also overlays the properties of the riblet structure, so that, in total, its characteristics described above are masked. For this reason, it is described in WO 2012/119965 A1 that biocides such as fungicides, algaecides, molluscicides and active compounds against shells and/or barnacles may be also added to this composite system additionally. Through the killing of microorganisms approaching the surface, colonization of the surface and thus biofilm formation can be minimized. Due to the high water solubility of many biocides, however, encapsulation of the substances inhibiting microbial growth in the composite system is necessary, for example, by polyurea-polyurethane, melamine resin or polyacrylate, to avoid washing out thereof. The approach described in WO 2012/119965 A2, however, is limited in its applicability. On the one hand the production of riblet structure using templates is complex and therefore associated with high cost. At the same time, due to this production method the finished composite systems are also limited in size.

In ES 2 322 839 A1 a similar approach for countering (bio)fouling is described. Here, a fabric coating for boat hulls or aircraft is disclosed, which exhibits an additional polymer lamination. Herein, the fabric can have different structures. In this document, however, no method is mentioned by which a riblet structure is available inexpensively.

Document DE 10 2010 011 750 A1 relates to a metal fabric or composite fabric which can be sticked or spanned on airplanes, wherein a rib structure with a multitude of mutually parallel ribs is formed by the metal wire arrangement, thus forming a shark skin structure. A particular advantage of this fabric is its high wear and erosion resistance, with the result that attachment to aerodynamically highly stressed surface areas of an aircraft, such as in the area of the wing leading edges, the horizontal stabilizer leading edges and also the vertical stabilizer leading edges, is possible. The fabric used herein is made of weft and warp threads which have the same diameter. The wires are made of a chromium-nickel steel alloy or titanium alloy to ensure a sufficient corrosion resistance. This material causes that this fabric is very expensive and even too expensive for less heavily stressed areas of the protected molded bodies, and thus not economical.

In WO 91/17292 A1 a fabric for use as dewatering screen in a paper machine is described. This fabric is manufactured by an intricate weaving technique necessarily using three wefts, the wefts having a different diameter than the warp. This results in a structure in which the bottom weft has an increased volume on one side of the fabric, whereby during use its abrasion is possible without disintegration of the fabric. However, from the fact that this fabric is used as a sieve, it has a specific denseness, wherein the fluid resistance of the fabric is completely irrelevant. A particular disadvantage is most notably the complicated weaving process using three wefts.

U.S. Pat. No. 4,462,916 A describes a mantle fabric of a filter element, which is made of a weft thread which has a larger diameter than the warp thread. This fabric also has to be permeable to fluid media, as it is used for filtering out impurities from the fluid medium.

Therefore there was a strong interest in provision of a surface with a riblet structure which eliminates at least one, preferably all of the disadvantages of the prior art. In particular, the present invention was based on the task to provide a surface with a riblet structure which shows a minimized flow resistance, preferably a reduced flow resistance regarding the fabrics of the prior art, which at the same time is easy to produce. Herein, the surface should be particularly inexpensive to manufacture and preferably no strong limitation regarding its size should be imposed. It should be particularly preferred when the surface can be used for subsequent equipment of other surfaces, for example of molded bodies, such as ship hulls, aircraft or rotor blades.

These objectives are achieved by providing a fabric comprising at least one weft and at least one warp, wherein the fabric comprises a polymer layer on at least one surface, characterized in that the diameter of the weft is larger than the diameter of the warp.

In particular by the fact that the invention is a fabric, surfaces can be provided that are simple and inexpensive to manufacture, and there is no strong limitation regarding the size of the surface to be produced as in the methods that can be found in the prior art. At the same time the fabric according to the invention is equipped with additional properties by the applied polymer layer.

Fabric with Polymer Layer

For the purposes of the present invention, a fabric is understood to be a product of at least two substantially orthogonally crossed threads. The result is a substantially planar structure. Preferably, the term “substantially orthogonally” refers to a structure, whose at least two threads, the weft thread and the warp thread, run in an angle of 90°±30°, particularly preferably 90°±20°, most preferably 90°±10°. As a warp thread, the thread which is attached in a loom in the longitudinal direction is understood. In the finished fabric, this warp thread is aligned parallel to the selvage. The weft, in contrast, is essentially drawn perpendicular to the warp yarn through the shed in the loom. By this intermesh the weave essential for the fabric arises. The preparation of fabrics is known to the person skilled in the art. The skilled person also knows different pattern repeats, that is, variations in the number of warp and weft threads, after which the weave is repeated. However, it is preferred that the fabric according to the invention is a single layer fabric, that is, a fabric made of only a warp and a weft system. For the purposes of the present invention, the term “at least one thread” is used in the sense of a thread system. This means in particular that the fabric may comprise a plurality of threads of the one and/or the other kind (this is particularly necessary usually due to the limited length of the individual threads). However, when thread systems are considered, it is essentially about the ratio of the number of warp threads to the number of weft threads. Preferably, the fabric according to present invention comprises a warp and a weft as single thread system. Herein, it is also known to the person skilled in the art how to use different warp and weft thread systems.

The cross-sections of at least one weft and at least one warp may be shaped independently from each other. Herein also asymmetrical cross-sections are comprised. In particular, cross-sections of twined and untwined yarns are included. Regardless of the shape of the cross section, the diameter (d) of a thread within the meaning of the present invention is always the longest distance which can be measured with a straight line between two points the farthest from each other lying on of the cross-section perimeter of a thread (see FIG. 1 a to d).

Surprisingly, it turned out that by using a weft of a diameter that is larger than the diameter of the warp, a fabric having a riblet structure can be produced. The resulting structure shows in particular a lower flow resistance than the fabrics known from the prior art. For the purpose of the present invention, a surface geometry referred to as a riblet structure preferably has longitudinal grooves. Therein, these are furthermore preferred to be grooves with a depth ranging from 10 to 1000 μm, more preferably 250-750 μm, most preferably 400 to 600 μm. The groove distance between two grooves preferably 10 to 1000 μm, more preferably 250 to 750 μm, most preferably 200 to 600 μm. Also preferably, these grooves have a length in the range of 10 μm to 10 mm.

In a preferred embodiment, the diameter of the at least one weft is 2 to 5 times, particularly preferably 3 to 5 times larger than the diameter of the at least one warp. It is particularly preferred that the diameter of all weft threads is 2 to 5 times, more preferably 3 to 5 times larger than the diameter of all warp threads. Thus, the diameter of the weft thread system is preferably 2 to 5 times, particularly preferably 3 to 5 times larger than the diameter of the warp thread system.

In general, it is preferred that the cross section of at least one weft is substantially round. Likewise, it is preferred that the cross section of at least one warp thread is substantially round. Very particular preferably, the cross-section of at least one weft thread and the at least one warp thread are round. The term “substantially round” herein means preferably that a deviation from the ideal circular shape is possible, but the actual radius (r′) of the thread cross-section on a specific point deviates at most 25%, particularly preferably at most 10% from the mean value (r) which describes the radius of a perfect circle (see also FIG. 1d). It has been found that such a fabric in which both the at least one weft as well as the at least one warp thread have a substantially circular shape forms a riblet structure, which has a particularly low flow resistance.

Particular preferably, the warp thread has a diameter of 0.1 to 1 mm, particularly particular preferably from 0.25 to 0.75 mm, very particular preferably from 0.4 to 0.6 mm.

Furthermore, it is preferred that the at least one weft thread and the at least one warp thread are not made of metal. Particularly preferably, the at least one weft thread and the at least one warp thread independently from each other comprise a material which is selected from the group consisting of glass fibers, polyamides and polyesters. Most preferably, the at least one weft thread and the at least one warp thread are made independently from each other from a material which is selected from the group consisting of glass fibers, polyamides and polyesters.

Depending on the material from which the threads used are made, formable or rigid fabrics may result. Depending on the application either plastic deformability or rigidity of the fabric may be desired.

The fabric according to the invention has a polymer layer on at least one surface. The fabric is, as described above, a planar structure. The fabric according to the invention preferably exhibits the polymer layer at least on one of the surfaces which is formed by stringing together of the at least one weft thread or of the at least one warp thread, respectively. More preferably, the fabric according to this invention has a polymer layer on both planar surfaces. It is preferred that the polymer layer on the fabric is formed in a way that the polymer layer, and thus also the fabric, is substantially non-permeable to water. By this, in particular the penetration of water, for example salt water, into the system, that is, the fabric structure can be prevented. Such penetration could lead to destabilization of the system.

The polymer layer on the fabric is preferably not soluble in water. Particularly preferably, the polymer layer is substantially non-swellable in water. This means that the polymer layer is either based on a polymer whose solubility in water is very low, or based on a polymer that is soluble in water but is cross-linked chemically and/or physically such strong that swelling in water is substantially avoided. Preferably, the polymer layer is formed from a polymer which has a polymerization degree of at least 10000.

For the purposes of the present invention, the term “on at least one surface of a polymer layer” is understood in that the fabric is covered on at least one surface by the polymer layer in a way that the properties of the materials forming warp and the weft are overlaid by the overlying polymer layer. This means that they are either essentially masked completely by the properties of the polymer layer, or that the characteristics of the materials forming the warp and the weft thread interact with the polymer layer so that new properties result. The pure characteristics of the materials forming the warp and the weft thread, however, are on no account present anymore at the surface which exhibits a polymer film. This applies exclusively to the characteristics of the materials forming the warp and the weft thread, and not to the properties of the resulting fabric (riblet structure). These properties are also retained after application of the polymer layer.

Preferably, the polymer layer is a polymer layer of low surface energy. Particularly preferably, the polymer layer is an “easy-to-clean” surface with properties of repellency of dirt and microorganisms known to the expert. Polymer systems with appropriate properties are known to the person skilled in the art. Particularly preferably, an “easy-to-clean” surface has a contact angle of more than 90° and a surface tension of less than 20 mJ/m².

Particularly preferably, the polymer layer has a contact angle of more than 70°, more preferably more than 80°, very particularly preferably more than 90°. This has to be understood in the way that the contact angle of the polymer layer is to be measured on a planar substrate. If the contact angle is measured on the fabric according to the invention itself, the surface topography would also have an influence on the contact angle, whereby the actual contact angle of the polymer layer cannot be determined correctly. For the determination of the contact angle methods known to a person skilled in the art are used. In particular, the specified contact angle is a mean value of at least three static contact angles of water at room temperature as measured by the “sessile drop” method with a contact angle measuring instrument.

Preferably, the polymer layer has a surface tension γ of less than 40 mJ/m², more preferably less than 30 mJ/m², very particularly preferably less than 20 mJ/m². The surface tension of the polymer layer, as well as the contact angle, is measured by the application of the polymer layer on a planar substrate, and not on the fabric according to the invention itself. Methods for the determination of the surface tension are also known to the person skilled in the art. In particular, the surface tension can also be determined by measuring of the surfaces by contact angle with at least three different solvents whose surface tension is known, and subsequent calculation based on known formulas, preferably by the method according to Zisman, Fowkes, Extended Fowkes, WORK, Schultz or Oss & Good.

Preferably, the polymer layer comprises a polymer which is selected from the group consisting of polymeric fluorinated hydrocarbons, polysiloxanes, polyolefins, polymeric fluorosilanes, copolymers of the aforementioned polymers, derivatives of the aforementioned polymers and polymeric organofunctionalized silanes. Particularly preferably, the polymer layer comprises a polymer which is selected from the group consisting of polysiloxanes, copolymers comprising polysiloxanes and derivatives of polysiloxanes.

The polymeric fluorinated hydrocarbons are preferably fluorocarbons. Herein it is furthermore preferred that the fluorocarbons are selected from the group consisting of polyvinyl tetrafluoride, polyvinylidene difluoride and polyvinyl fluoride. Copolymers of fluorocarbons are preferred perfluoroalkoxy polymers (PFA), such as copolymers of tetrafluoroethylene and perfluorovinylmethyl ether, for instance. In one embodiment of the present invention the fluorinated hydrocarbons are no perfluorinated hydrocarbons.

By a reduced amount of fluorine atoms per repeating unit, the adhesion of the polymer layer on the fabric can be optimized in this embodiment. Particularly preferably in this embodiment the repeating units of the fluorinated hydrocarbons have a ratio of hydrogen to fluorine of 1:1.

Polysiloxanes are preferred polymers for the polymer layer according to the invention. With these, in particular, a surface can be obtained, which meets the hydrophobicity criteria of the present invention. The polysiloxanes are preferably polysiloxane resins, ie polysiloxanes with a correspondingly high degree of branching, or linear polysiloxanes, such as for instance hydrosilyl-polydimethylsiloxane, which are crosslinked subsequently. Copolymers of polysiloxanes preferably comprise polyether polysiloxanes, polymethylsiloxane-poylalkylsiloxanes or polymethylsiloxane-polyalkylsiloxane polyethers.

As “derivatives” of the mentioned polymers are in particular understood polymers which have derivatizations on their side chains, which, however, do not cause fundamental changes of properties of the main chain of the polymer. For example, such derivatives of the mentioned polymers can have side groups which effect cross-linking with other side chains and/or the main chain of the polymer. By this, the mechanical properties of the polymer layer can be improved. Likewise, these side chains can improve adhesion of the polymer layer on the fabric according to the invention. Furthermore, it is possible that the side groups contain derivatives which have biocidal properties, so that the adhesion of microorganisms to the fabric according to the present invention can be avoided additionally (for example, Krishnan S., Weinman J., Ober C. K., Advances in Polymers for Anti-Biofouling surfaces, Journal of Materials Chemistry 2008, 18, 3405). Combinations of the aforementioned side groups on a polymer derivative are also possible.

In general, polymeric organofunctionalized silanes are understood by a person skilled in the art as polymers which comprise the following general structure (I):

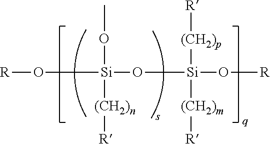

Hence, organofunctionalized silanes constitute a subset of derivatives and/or copolymers of polysiloxanes. Herein, the groups R′ may in particular be functional groups which are selected from the group consisting of —C₆H₅, —SH, —NH₂, —(CF₂)₅CF₃, —N±Me₃Cl⁻, —O—CH₂—CH(O)CH₂, —CH═CH₂, —OC(O)CH═CH₂ and —OC(O)C(CH₃)═CH₂. The numbers n, m and p can independently be preferably 1 to 6 and s can preferably be 0 to 3. R is preferably H or —CH₃ and q is preferably 10000.

When organofunctionalized silanes are applied to form the polymer layer, the use of a solvent, water or mixtures thereof is preferred.

The polymer layer can also comprise further components, which are selected from the group consisting of pigments, low molecular weight crosslinking agents, biocides, antioxidants, UV absorbers, flame retardants, elastomeric modifiers, processing aids (lubricant), clarifiers, nucleation agents and fillers. These further components can also be used for subsequent curing/crosslinking of the polymer layer. Corresponding processes dependent on the selected type of polymer are known in the art.

The polymer layer protruding the fabric surface (see FIG. 2) has a layer thickness X1, which allows that the riblet structure of the fabric on the surface equipped with the polymer layer is not lost. Particularly preferably, the protruding polymer layer has a layer thickness of 100 to 500 μm, more preferably of 150 to 450 μm, most preferably of 200 to 400 μm. Surprisingly, it has been found that the riblet structure of the fabric and the properties of the polymer layer interact synergistically. In particular, a surface can be obtained whose (bio)fouling tendency is lower than the corresponding tendency for either the fabric or the polymer layer alone.

The polymer layer can be applied onto the fabric in different ways. As film thickness of the protruding polymer layer (X1) in accordance with the present invention is always termed the thickness of the polymer layer above the center of the intersection of warp and weft thread (see FIG. 2a-2c). Therein, polymer of the polymer layer that has penetrated the fabric is possibly not assigned to the layer thickness of protruding polymer. This is in each case measured only from the end of the thread lying on top (warp or weft, respectively) to the end of the polymer layer.

In a preferred embodiment, the application of the polymer layer onto the fabric can take place by lamination of at least one prefabricated polymer film. Preferably two films are used, so that they are laminated onto both sides of the fabric. Therein the two films can be the same or different. In particular, the layer thicknesses of the films may be the same or different. The lamination is preferably effected by heating the polymer film. The temperatures to be used and conditions of this lamination depend on the nature of the polymer film and belong to the knowledge of a person skilled in the art. The protruding layer thickness (X1) of the polymer layer substantially corresponds to the thickness of the polymer film.

In another preferred embodiment, the application of the polymer layer onto the fabric can be carried out by impregnation by means of a polymer dispersion. In this case, the fabric is soaked in the polymer dispersion. By adjusting the viscosity of the polymer dispersion, the resulting protruding layer thickness (X1) of the polymer layer can be adjusted. In this embodiment it can be adjusted, depending on the amount of the polymer dispersion in which the fabric is impregnated, whether only one surface of the fabric, or both surfaces are modified with the polymer layer. When both surfaces of the fabric have a polymer layer, their protruding layer thickness (X1) may be the same or different. In this variation it is possible that the polymer of the polymer layer also penetrates the fabric deeply, or penetrates it completely, respectively. Herein, the single threads of the fabric are thus coated by the polymer of the polymer layer (regarding definition of the protruding layer thickness of the polymer layer (X1) see above).

By combination of the topographical characteristics of the fabric with the properties of the polymer layer, the fabric according to the invention has particular dirt-repellent and anti-icing properties. Furthermore, UV-stable, salt-water stable, chemically stable, thermally stable, durable and corrosion-resistant surfaces result from this. At the same time, the surfaces exhibit friction-reducing, flow resistance-minimizing surfaces, whereby, for example, by application of the fabric according to the invention to a rotor blade of a wind power plant, the noise generation can be minimized. The description of the influence of a riblet structure on a 3D flow field is known and can be obtained by discrete solution of Navier-Stokes equations using the finite volume method.

A Biocidal Fabric with Polymer Layer

In an embodiment of the present invention, the polymer layer further comprises nanoparticulate silver.

In the present invention, the term “particulate silver” is preferably understood as elemental silver in nanoparticulate form, silver oxide in nanoparticulate form as well as mixtures of these two.

It is known that particulate silver has antimicrobial activity (see for example EP 1 964 966 A1). By the use of particulate silver in the polymer layer of the fabric according to the invention, this can thus be additionally equipped with antimicrobial properties. The term “anti-microbial properties” in the context of the present invention is understood as a biocidal or biostatic effect against bacteria, fungi, algae, yeasts, viruses etc. The means that the antimicrobial equipment of the polymer layer is capable, by chemical or biological means, to destroy, deter and to render harmless harmful organisms, prevent damage caused by them or to fight them in another way (definition from the German Biocides Law from the year 2000).

In contrast to standard biocides the antimicrobial effect of the silver nanoparticles is not due to the release of a drug, but to its provision on the surface of the fabric according to the invention. As no drug-consumption takes place here, this approach is a sustainable solution. In addition, thus no biocides are, for example, released into the oceans. Such release can lead to an accumulation of the active substance in the environment with corresponding effects on the natural balance. Therefore, this concept is also an environmentally friendly method. Furthermore, the development of resistances of microorganisms, which can often be observed with the gradual decrease of the released drug concentration at respective surfaces, can be minimized. Since nanoparticulate silver exerts its antimicrobial effect by numerous modes of action, the risk of resistance formation is further reduced. One of these mechanisms is the interaction of nanoparticulate silver in terms of silver partial charge or a polarization with structural proteins of microorganisms (see also EP 1964966 A1).

By the addition of nanoparticulate silver to the polymer layer, however, further properties can also be imparted to the layer. Thus, the addition of nanoparticulate silver influences the IR-reflection of the polymer layer and also makes it electrically conductive.

Preferably, the nanoparticulate silver exhibits an average grain size of less than 500 nm, more preferably less than 100 nm, even more preferably less than 50 nm. Particularly effective is a mean particle size of 5 to 50 nm. In further embodiments of the proposed additional equipment of the polymer layer with nanoparticulate silver, its average grain size is 5 to 30 nm, particular preferably 6 to 25 nm, in particular 7 to 20 nm, especially 8 to 16 nm, more especially 10 to 14 nm. The particle size is therein determined by photon correlation spectroscopy in aqueous solution. This particle size is particularly preferred since hereby a large surface area is provided, from which the nanoparticulate silver takes effect. By this, the amount silver required for the antimicrobial equipment of the polymer layer can be reduced.

The nanoparticulate silver particles can take any form. It is preferred, however, that the nanoparticulate silver particles are spherical, particularly preferably ball-shaped. This shape allows easier incorporation of the silver into the polymer layer.

The preparation of nanoparticulate silver per se is known and suitable nanoparticulate silver can be obtained commercially, for example from Fraunhofer Institute for Chemical Technology, Germany.

The amount of nanoparticulate silver in the polymer layer is preferably 100 ppm, more preferably 50 ppm, even more preferably 10 ppm. In particular, it is possible to use such small amounts of nanoparticulate silver in the polymer layer, since the silver is anchored firmly in said layer. On contact with fluid media, especially with salt water, it is not leached. The nanoparticulate silver is anchored in the polymer system of the polymer layer via dipole-dipole interactions, whereby an uncontrolled release is avoided.

### Additional Adhesive Layer

In a further preferred embodiment, which in particular can also be combined with the embodiment “biocidal fabric with a polymer layer” the fabric of the present invention has an additional adhesive layer. This is either applied onto the surface of the fabric which does not exhibit a polymer layer, or, under the proviso that a polymer layer is present on both surfaces of the fabric, applied to the surface of a polymer layer.

In particular in the aerospace industry, finishes are already used at present which minimize the resistance that is opposed by the air to, for example, an airplane. However, aircraft have to be maintained regularly to examine their skin for damages such as microcracks. For this, the finish has to be removed (“stripped”). On one hand this requires effort, and on the other hand it is neither sustainable nor cost-optimized due to the waste of raw materials.

By applying an adhesive layer onto a surface of the fabric according to this invention, this can be easily applied to any surface which is to be equipped with the fabric according to the invention on the one hand. Preferably, however, the adhesive force of the adhesive layer is selected in a way such that detachment of the fabric of the invention from the surface is possible. Thus, it can be easily removed again on the other hand. After the detachment of the fabric according to present invention from a surface it is even also possible to reuse it. Also by this, additional costs and resources can be saved.

The adhesive layer is preferably formed from a solvent-free polymer dispersion. Herein, Preferably either 1- or 2-component systems are used.

The resulting thickness of the adhesive layer is preferably between 50 and 800 μm, more preferably between 100 and 500 μm, most preferably between 200 and 300 μm. The resulting layer thickness can be knife-coated onto the surface of the fabric, or if this has a polymer layer on both surfaces, onto the polymer layer. The resulting thickness of the adhesive layer can be adjusted by the doctor blade used and also by adjustment of the viscosity of the dispersion. The viscosity of the dispersion can be varied by the degree of polymerization of the polymer used, for example.

In a preferred embodiment, the adhesive layer is formed from a polymer based on silicone. Particularly preferably this refers to hydrosilyl-siloxanes. These may have different degrees of branching. Particularly preferably, the polymer of the adhesive layer exhibits a degree of polymerization of 5000.

Particularly preferably, the adhesive layer has a high temperature stability. Herein, the adhesive layer is preferably thermally stable up to 150° C., more preferably up to 200° C., even more preferably up to 260° C.

In a further aspect of the present invention, a molded body is provided on which the fabric according to the invention is attached following one of the embodiments described above. Preferably, the shaped body is therein selected from the group consisting of a boat's/ship's hull, a rotor blade and an aircraft fuselage.

The present invention also relates to the use of the fabric according to the invention in one of the embodiments described above for the equipment a surface with dirt-repellent, anti-friction and/or noise-reducing properties. As already described above, these properties are in particular created by the riblet structure in combination with the polymer layer.

When nanoparticulate silver is additionally admixed to the polymer layer, the present invention also relates to the use of the fabric according to the invention in one of the embodiments described above for the equipment a surface with antimicrobial, IR-reflective and/or electrically conductive properties. In particular, the fabric according to the present invention can inhibit or stop, respectively, the growth of bacteria such as gram-positive and gram-negative bacteria, such as for example Chlamydia trachomatis, Citrobacter, Providencia stuartii, Vibrio vulnificus, Staphylococcus aureus, Staphylococcus epidermidus, Escherichia coli, Pseudomonas maltophilia, Serratia marcesens, Bacillus subtilis, Bacillus cloacae, Bacillus allantoides, Bacillus foecalis alkaligenes, Pneumobacillus, nitrate-negative bacillus, Streptococcus facades, Streptococcus hemolyticus B, Salmonella typhinurium, Salmonella paratyphi C, Salmonella morgani, Pseudomonas aeruginosa. Furthermore, the fabric according to the invention can, by adjusting the content of nanoparticulate silver, concentration-dependently inhibit the growth of higher organisms, such as algae, fungi, filamentous fungi (Aspergillus, such as Aspergillus niger, Aureobasidium, Botrytis, Candida Albicans, Ceratostomella, Chaetomium, Cuvularla, Fusarium, Gliocladium viens and Penicillium strains), yeasts and spores.

Altogether, a multifunctional fabric and its respective use are therefore provided by the present invention. Depending on the choice of the material forming the fabric according to the invention, the fabric according to the invention can either be fitted flexibly to the surface to be equipped, or support the mechanical stability of the surface to be equipped through its rigidity.

### Method

In a further aspect of the present invention a method for manufacturing a fabric is provided which comprises the following steps:
(a) Production of a fabric by interweaving of at least one weft and at least one warp, wherein the diameter of the weft is 3 to 5 times larger than the diameter of the warp; and
(b) Applying a polymer layer onto at least one surface of the fabric obtained in step (a).

Therein it is particularly preferred that a fabric according to the invention with all its full, previously described embodiments is obtained.

In one embodiment, the method according to the invention is characterized in that the application of the polymer layer onto the fabric in step (b) is
(b1) carried out by impregnation of the fabric with a polymer dispersion.

Preferably, this polymer dispersion is the polymer dispersion already described above. The viscosity of the polymer dispersion and thus resulting protruding layer thickness (X1) of the polymer layer can be preferably controlled by the degree of polymerization of the polymer in the polymer dispersion. In one embodiment, nanoparticulate silver can be added to this polymer dispersion. Therein it is preferable that 0.1 to 10 vol.-%, particularly preferably 0.5 to 8 vol.-%, and very particularly preferably 1 to 6 vol.-% of a nanoparticulate silver dispersion added to the polymer dispersion are used, based on the total volume of the polymer dispersion. In this way, the biocidal fabric with polymer layer according to the invention described above can be obtained.

In this embodiment, it is preferred that the fabric is dipped into the polymer dispersion in a way that it is at least completely covered by the polymer dispersion. By this, a fabric that has a polymer layer on both surfaces results. In particular, by the step (b1) substantially all threads of the fabric are coated by a polymer layer. Processes for curing/crosslinking of the applied polymer layer depend on the type of polymer used and are known in the art. Optionally, further components, as already described above, can also be admixed to the polymer dispersion.

In another embodiment, the method according to the invention is characterized in that the application of the polymer layer to the fabric in step (b) is
(b2) carried out by lamination of a polymer film on at least one side of the fabric.

The method of lamination is known to the person skilled in the art. In particular, a calendering method is used therefor. For this purpose, a polymer film is preferably applied with heating and further preferably applied on both sides of the fabric.

Also in this embodiment, it is possible that nanoparticulate silver is firstly admixed to the polymer film in order to obtain the above-described biocidal fabric with polymer layer according to the invention. Herein, a granulated polymer is first mixed with nanoparticulate silver and therefrom the corresponding polymer film is prepared.

In a preferred embodiment the method according to the invention comprises the additional the step of:
(a) Applying an adhesive layer onto a surface of the fabric or, provided that the polymer layer is present on both surfaces of the fabric, to the surface of the polymer layer.

This preferably refers to the adhesive layer described above. Particularly preferred the application of the adhesive layer in this step (c) is carried out by knife-coating of a dispersion.

In a preferred embodiment of the method according to the invention the steps (a) and (b) and optionally also (c) are performed in a continuous process. This has the particular advantage that the manufacturing process of the fabric according to the invention can thus be carried out easily and, most of all, inexpensively.

### DESCRIPTION OF THE FIGURES

FIG. 1: Exemplary representation of the different forms of cross-sections of the warp and/or weft threads. The diameter (d) of the cross-sections is the value for the distance which is measured for a straight line connecting of the points lying farthest from each other on the line of cross-sectional circumference. FIG. 1a illustrates an elliptical cross-section. FIG. 1b illustrates a square cross-section. FIG. 1c illustrates an asymmetrical cross-section. FIG. 1d illustrates a substantially round cross-section, where “substantially round” preferably means that the actual radius (r′) of the thread cross-section at a certain point deviates at maximum by 25% from the mean value (r), which is described by the radius of a perfect circle (dashed line). The use of the mean value and the actual radius serves solely the description of the shape of the cross section. Still, the value of the distance that can be measured by connecting the points lying farthest from each other on the line of cross-sectional circumference with a straight line is considered to be the diameter.

FIG. 2: Representation of the fabric according to the invention

FIG. 2a: Exemplary representation of the lamination of the fabric with the polymer layer (P) (the representations of size are not binding). The polymer layer (P) has a thickness (X) and is applied onto the fabric of the weft thread (S) (exemplified with rectangular cross-section) and the warp thread (K) (exemplified with round cross-section).

FIG. 2b: Fabric according to the invention after lamination of the polymer layer (P) onto the fabric (see FIG. 2a). The polymer layer (P) substantially keeps its layer thickness (X), from which a resulting protruding layer thickness of the polymer layer (X1) clinging to the fabric topography emerges.

FIG. 2c: Fabric according to the invention after impregnation. The fabric is herein formed from the warp thread (K) and the weft thread (S) (both with round cross-section). Onto this fabric, a polymer layer was applied by the method of impregnation. These resulting polymer layer (P) varies partially in its thickness. It is also possible that the polymer layer (P) penetrated into the fabric more deeply by the impregnation. The layer thickness above the center of intersection of the warp and the weft thread is termed the layer thickness (X1) of the protruding polymer layer (P) in each case.

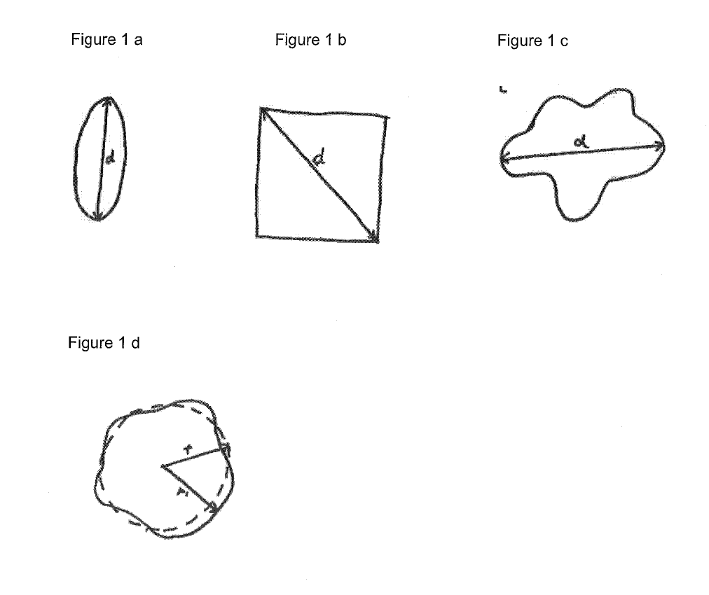

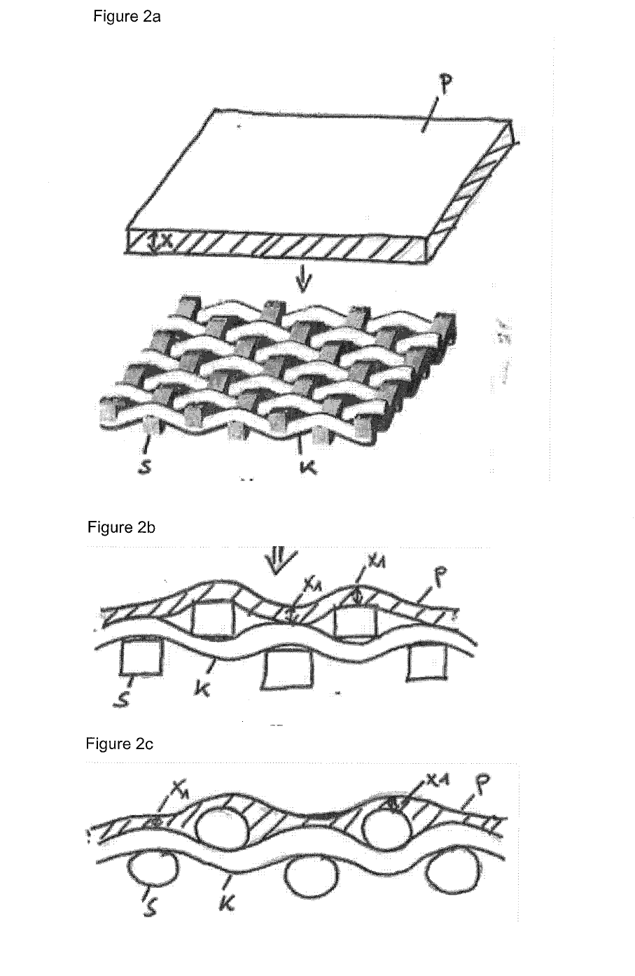

1-15. (canceled)

16. A fabric, comprising at least one weft thread and at least one warp thread, wherein the fabric exhibits a polymer layer on at least one surface, characterized in that the diameter of the weft thread is 3 to 5 times larger than the diameter of the warp thread.

17. The fabric according to claim 16, characterized in that the polymer layer has a contact angle larger than 70°.

18. The fabric according to claim 16, characterized in that the polymer layer has a surface tension of less than 40 mJ/m².

19. The fabric according to claim 16, characterized in that the at least one weft thread and the at least one warp thread independently of each other comprise a material which is selected from the group consisting of glass fibers, polyamides and polyesters.

20. The fabric according to claim 16, characterized in that the polymer layer comprises a polymer, which is selected from the group consisting of polymeric fluorinated hydrocarbons, polysiloxanes, polyolefins, polymeric fluorosilanes, copolymers of the aforementioned polymers, derivatives of the aforementioned polymers and polymeric organofunctionalized silanes.

21. The fabric according to claim 16, characterized in that the polymer layer further comprises silver nanoparticles.

22. A fabric according to claim 16, characterized in that the fabric has an additional adhesive layer, which is either applied onto the surface of the fabric which does not exhibit a layer of polymer, or which, under the proviso that a polymer layer is present on both surfaces of the fabric, is applied onto the surface of a polymer layer.

23. The fabric according to claim 20, characterized in that the polymer layer comprises a polymer, which is selected from the group consisting of polymeric fluorinated hydrocarbons, polysiloxanes, polyolefins, polymeric fluorosilanes, copolymers of the aforementioned polymers, derivatives of the aforementioned polymers and polymeric organofunctionalized silanes.

24. The fabric according to claim 23, characterized in that the polymer layer further comprises silver nanoparticles.

25. A fabric according to claim 24, characterized in that the fabric has an additional adhesive layer, which is either applied onto the surface of the fabric which does not exhibit a layer of polymer, or which, under the proviso that a polymer layer is present on both surfaces of the fabric, is applied onto the surface of a polymer layer.

26. A molded body, onto which a fabric according to claim 16 is applied.

27. The molded body according to claim 26, wherein the molded body is selected from the group consisting of a boat's/ship's hull, a rotor blade and an aircraft fuselage.

28. A method of at least one of repelling dirt, reducing friction and reducing noise, the method comprising applying the fabric according to claim 16 to a substrate selected from the group consisting of a boat's/ship's hull, a rotor blade and an aircraft fuselage to impart to the substrate at least one of dirt-repellent, friction-reducing, and/or noise-reducing properties.

29. A method of at least one of providing antimicrobial, IR-reflective and/or electrically conductive properties, the method comprising applying the fabric according to claim 16 to a substrate selected from the group consisting of a boat's/ship's hull, a rotor blade and an aircraft fuselage to impart to the substrate at least one of antimicrobial, IR-reflective and/or electrically conductive properties.

30. A method for the production of a fabric according to claim 16, comprising the steps of:
(a) producing a fabric by interweaving at least one weft thread and at least one warp thread, wherein the diameter of the weft thread is 3 to 5 times larger than the diameter of the warp thread; and
(b) applying a polymer layer to at least one surface of the fabric obtained in step (a).

31. The method according to claim 30, characterized in that the application of the polymer layer to the fabric in step (b) is
(b1) carried out by impregnation of the fabric with a polymer dispersion.

32. The method according to claim 30, characterized in that the application of the polymer layer to the fabric in step (b) is
(b2) carried out by lamination of a polymer film on at least one side of the fabric.

33. The method according to claim 30, further comprising the step of:
(c) applying an adhesive layer onto a surface of the fabric or, provided that the polymer layer is present on both surfaces of the fabric, to the surface of the polymer layer.

34. The method according to claim 30, characterized in that the steps (a) and (b) and optionally also (c) are carried out in a continuous process.

35. The method according to claim 30, characterized in that the steps (a), (b) and (c) are carried out in a continuous process.
